(19) United States
(12) Patent Application Publication
(10) Pub. No.: US 2013/0225240 A1
(43) Pub. Date: Aug. 29, 2013

(54) SPEECH-ASSISTED KEYPAD ENTRY

(71) Applicants: Henry P. Largey, Wylie, TX (US); Gabriel Rivera, Coppell, TX (US)

(72) Inventors: Henry P. Largey, Wylie, TX (US); Gabriel Rivera, Coppell, TX (US)

(73) Assignee: NVIDIA Corporation, Santa Clara, CA (US)

(21) Appl. No.: 13/408,866

(22) Filed: Feb. 29, 2012

(51) Int. Cl. G06F 3/02; G10L 15/00; H01H 11/00; H04W 88/02

(52) U.S. Cl. 455/563; 29/622; 704/E15.001

(57) ABSTRACT

An electronic device is configured to receive data from a keypad key, wherein the key is associated with first and second alphanumeric characters. The device includes a keypad interface and a data entry processor. The keypad interface is configured to determine the first and second alphanumeric characters when the key is pressed. The data entry processor is configured to select the first alphanumeric character from among the first and second alphanumeric characters when a speech recognizer determines that a spoken entry identifies the first alphanumeric character.

### TECHNICAL FIELD

This application is directed, in general, to devices, systems and methods for controlling operation of electronic devices.

### BACKGROUND

Various electronic devices include a keypad for data entry. The keypad may be used in some contexts, such as telephone dialing, to enter a single alphanumeric character, e.g. a digit, corresponding to each key. In other contexts the keys may be associated with two or more alphanumeric characters. For example, on the familiar telephone keypad the “number 2” key is associated with “A”, “B”, “C” and “2”. With a key modifier, the key may also be associated with “a”, “b” and “c”. Data entry sometimes includes first pressing the key of interest, and then pressing it again one or more times to select the desired alphanumeric character. Such data entry may be cumbersome and unreliable for some users of such devices.

### SUMMARY

One embodiment provides an electronic device configured to receive data from a keypad key, wherein the key is associated with first and second alphanumeric characters. The device includes a keypad interface and a data entry processor. The keypad interface is configured to determine the first and second alphanumeric characters when the key is pressed. The data entry processor is configured to select the first alphanumeric character from among the first and second alphanumeric characters when a speech recognizer determines that a spoken entry identifies the first alphanumeric character.

Another embodiment provides a system for entering data into an electronic device. The system includes a receiver, a data discriminator, a speech recognizer and a character transmitter. The receiver is configured to receive keypad entry data from the electronic device. The data discriminator is configured to determine a pressed key from among at least a first key and a second key of the keypad. The speech recognizer is configured to receive a spoken entry that corresponds to a first or a second alphanumeric character associated with the pressed key. The character transmitter is configured to transmit to the electronic device a signal indicating which of the first and second alphanumeric characters is designated by the spoken entry.

Yet another embodiment provides a method, e.g. for forming a keypad-operated electronic device. The method includes configuring a keypad interface to determine that a keypad key has been pressed. A speech recognizer is provided that is configured to process a spoken entry including a spoken equivalent of a first alphanumeric character associated with the key. A data entry processor is coupled to the speech recognizer. The data entry processor is configured to select the first alphanumeric character from among a plurality of alphanumeric characters associated with the key when the speech recognizer determines that the spoken entry identifies the first alphanumeric character.

### BRIEF DESCRIPTION

Reference is now made to the following descriptions taken in conjunction with the accompanying drawings, in which:

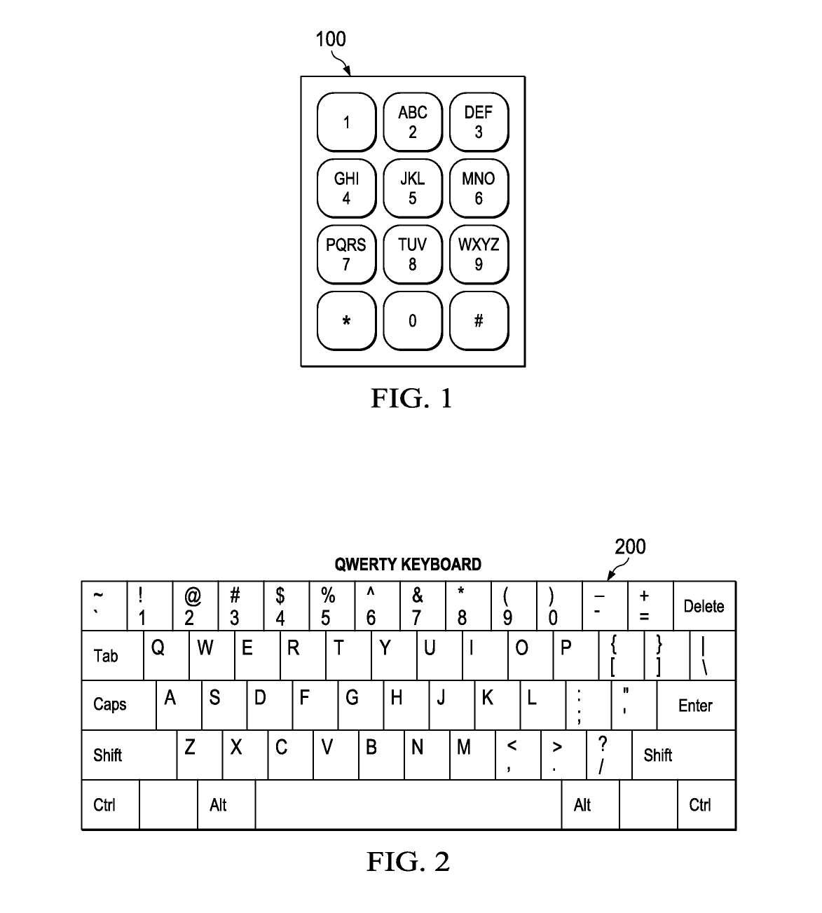

FIGS. 1 and 2 respectively illustrate an alphanumeric keypad and a full keyboard that may be employed by electronic devices according to various embodiments;

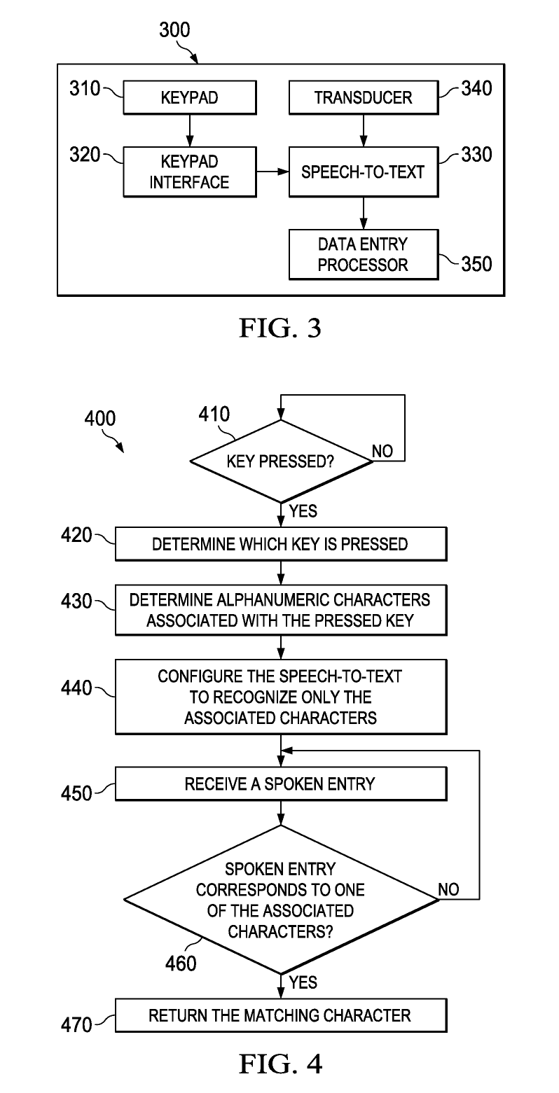

FIG. 3 illustrates an electronic device according to one representative embodiment, in which a pressed key and a spoken entry are used to determine a selected character;

FIG. 4 illustrates a method, e.g. for determining a selected character, that may be implemented by the electronic device of FIG. 3;

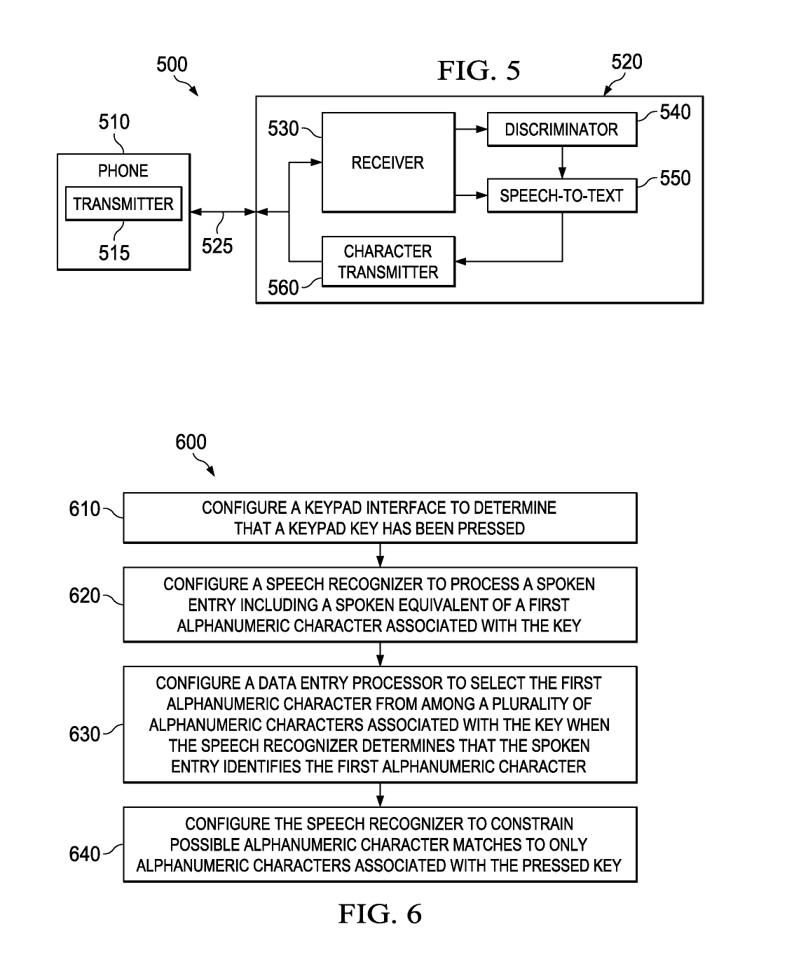

FIG. 5 illustrates a system including an electronic device and a remote server, wherein the server determines a selected character from a key pressed on the device and a spoken entry; and

FIG. 6 illustrates a representative embodiment of a method, e.g. for forming an electronic device such as the device of FIG. 3.

### DETAILED DESCRIPTION

Various embodiments described herein provide devices, systems and methods for improving data entry into an electronic device that employs a keypad for data entry. As hand-held electronic devices have become smaller, and include a greater number of features, the complexity of data entry into such devices has increased. Such data sometimes includes, e.g. phone numbers, email messages, text messages and address information. Difficulty entering such data increases the time needed to accurately enter the data, and sometimes causes user frustration.

Some possible strategies for easing the burden of data entry are possible, but deficient in one or more ways. For example, some cellular phones employ a method of multiple key presses, such as first pressing the key of interest, and then pressing it again one or more times to select the desired alphanumeric character. Not only is this system cumbersome, but for users that have large fingers, it may be difficult or nearly impossible to reliability press a single key. Speech recognition may be possible in theory, but typically requires complex algorithms, more powerful processing hardware, greater memory, and a relatively quiet ambient.

The inventors have recognized that data entry to an electronic device may be improved by combining key entry with targeted speech recognition. In various embodiments of the invention, a key may first be pressed. The key is assigned to an alphanumeric character, and associated with one or more other alphanumeric characters. After a user presses the key, the user may speak the assigned or other associated alphanumeric characters. The electronic device or a server in communication with the device may then determine the spoken character, constraining a character search to the assigned and associated characters. The search may therefore be faster and/or require fewer hardware and/or computational resources. Moreover, by constraining the character search, the determination of the selected character is expected to be significantly more robust to background noise that might otherwise mask the spoken character. When the selected, e.g. spoken, character is determined, the device may then register the character in memory.

Herein, the term “alphanumeric character” may be shortened to “character” without loss of generality. Herein, the word “associated” in the context of alphanumeric characters means either: 1) characters assigned to a single key of a keypad, or 2) characters assigned to keys that are the immediate neighbors of a pressed key. Thus, as described further below with reference to FIG. 1, in one example for the telephone key “2”, to which the characters “A”, “B” and “C” may be assigned, the characters “2”, “A”, “B” and “C” are all associated with the “2” key. In another example, on a QWERTY keyboard, the “G” key is associated with the characters “T”, “Y”, “H”, “B”, “V” and “F” by virtue of being immediate neighbors of “G”, and further associated with the character “G” because the character is assigned to the key. For the purpose of the claims, keys are not otherwise “associated” merely because they are present in a same key layout or same device, nor because they are members of a same character set.

Various embodiments of the disclosure are now presented with reference to the figure. These figures may include various functional modules, and the discussion may include reference to these modules and describe various module functions and relationships between the modules. Those skilled in the art will recognize that the boundaries between such modules are merely illustrative and alternative embodiments may merge modules or impose an alternative decomposition of functionality of modules. For example, the modules discussed herein may be decomposed into sub-modules to be executed as multiple computational processes and, optionally, on multiple electronic devices, e.g. integrated circuits. Moreover, alternative embodiments may combine multiple instances of a particular module or sub-module. Furthermore, those skilled in the art will recognize that the functions described in example embodiment are for illustration only. Operations may be combined or the functionality of the functions may be distributed in additional functions in accordance with the invention.

Turning to FIG. 1, a nonlimiting example of an alphanumeric keypad 100 is illustrated that may be used by an electronic device in various embodiments. The keypad 100 may be used, e.g. on a cellular telephone, but embodiments of the invention are not so limited. The keypad 100 conforms to the ISO/IEC 9995-9:2009 standard for keypad layout, but embodiments of the invention are not limited to keypads conforming to this standard.

Each of the keys “2”-“9” is associated with a number of characters. For example, each of these keys has a primary assigned character, e.g. “2”. . . “9”. In addition, each includes a number of secondary characters. For example, the secondary characters assigned to the “2” key are “A”, “B” and “C”. Conventionally these characters may be entered into various data fields by the aforementioned technique of multiple key presses. In some cases, the lower case versions of the illustrated secondary characters may also be entered using the multiple key press method.

FIG. 2 illustrates a conventional keypad 200 that may be used in various embodiments. The keypad 200 is distinguished from the keypad 100 by the presence of one key for each letter of the Roman alphabet. Herein and in the claims such a keypad, regardless of size or the specific pattern of keys, is referred to as a full keyboard. The keypad 200 is illustrated with the familiar QWERTY layout, but embodiments are not so limited. For example, alternative layouts include, e.g. the Dvorak layout. Characters in the keypad 200 may be associated in at least two ways. First, as described for the keypad 100, a key may have a primary assigned character, e.g. “6” and a secondary assigned character, e.g. “̂”. In some cases the secondary character may be a different case of the primary character, e.g. “H” and “h”. Characters may also be associated by proximity. Thus, as describe above, the “G” key may be associated with “G”, “Y”, “F”, “H”, “V” and “B”.

FIG. 3 illustrates an electronic device 300, e.g. a cellular telephone. While the description below may refer to embodiments of a cellular telephone, embodiments are not limited thereto. For example, the device 300 may be any electronic device consistent with the scope of the disclosure that uses a keypad or keyboard for data entry. Indeed the keypad described in the following embodiments may be a virtual (e.g. graphically rendered) keypad. Nonlimiting examples of electronic devices include, e.g. tablet computers (e.g. Android™ devices or Apple iPad™), or the Apple iPod Touch™. Such devices may be referred to herein as “small computing devices” without loss of generality.

The device 300 includes a keypad 310, e.g. the keypad 100, a keypad interface 320, a speech-to-text (STT) interface 330, a transducer 340 and a data entry processor 350. The transducer 340 may include, e.g. a conventional microphone element and an analog-to-digital converter (ADC). The keyboard interface 320, STT interface 330 and data entry processor 350 may be implemented by a processor and memory as well understood by those skilled in the pertinent art. Embodiments of the invention are not limited to any particular implementation, which may include without limitation, e.g. a commercial or proprietary integrated circuit, state machine, programmable logic, microcontroller or digital signal processor (DSP).

The keypad 310 has a set of characters that may be produced by appropriate selection of keys. For example, the complete set may include a . . . z, A . . . Z, 0 . . . 9 and some punctuation characters. The keypad interface 320 detects a key press on the keypad 310. The keypad interface 320 is configured to select from the character set a subset of characters that includes the primary character assigned to the pressed character, as well as any secondary characters. Thus, for example, when the “5” key is pressed, the keypad interface 320 may report the character subset {5, j, k, 1, J, K, L} to the STT interface 330.

After pressing the key, a user of the device 300 may then speak one of the characters associated with the pressed key. Continuing the previous example, after pressing the “5” key, the user may speak “j” (pronounced “jay”). The STT interface 330 receives the character subset from the keypad interface 320, and the spoken character from the transducer 340. The STT interface 330 then uses a speech recognition algorithm to determine the spoken character.

As appreciated by those skilled in the pertinent art, speech recognition may include an algorithm that implements a computational model such as the hidden Markov model (HMM). The HMM may include a Viterbi algorithm that may determine a most likely fit between an acoustic signature and a corresponding word.

Unlike a conventional speech recognition algorithm, the speech recognition algorithm of the STT interface 330 is configured to select a character from among the character subset provided by the keypad interface 320. Thus, not only is the universe of possible characters constrained relative to the full character set, but also the STT interface 330 need only detect and fit to a small number of sounds. For instance, in English many of the letters of the alphabet are spoken as a long “E” sound (International Phonetic Alphabet symbol i:) with a unique leading consonant. Because the number of unique sounds available in the full character set, and the further reduction of the number of sounds in the character subset, the complexity of the STT interface 330 may be significantly reduced relative to a conventionally configured speech recognition algorithm. Thus the STT interface 330 may be implemented using significantly less computational and hardware resources than possible for a conventional speech recognition algorithm.

In some embodiments the STT interface 330 may be configured to additionally recognize a small number of modifier keywords. For example, pressing the “2” key and speaking “bee” might indicate a lower case “b” by default. The user might press the “2” key and speak “upper bee” to indicate an upper case “B” is desired. The STT interface 330 may be configured to recognize the word “upper” and modify the selected character accordingly. Alternatively, the STT interface 330 may default to select an upper case character, and select the lower case equivalent only when the user speaks “lower”. Thus, a spoken entry may include in various embodiments a modifier keyword and a character to be modified. Those skilled in the pertinent art will appreciate this strategy may be implemented in many different ways without departing from the scope of the disclosure.

The data entry processor 350 receives the selected character from the STT interface 330 after the STT interface 330 has identified the character specified by the combination of the key press and the spoken character. The data entry processor 350 interfaces with other portions of the device 300 as necessary to effect the character entry, e.g. to a data memory or display memory (not shown).

FIG. 4 presents a method 400 with continued reference to FIG. 3 to illustrate operation of the device 300 according to one nonlimiting embodiment. In a step 410 the keypad interface polls the keypad 310 to determine if a key has been pressed. If no key is pressed, the method 400 remains in the step 410. If instead a key press is detected the method 400 advances to a step 420.

In the step 420 the keypad interface 320 determines which key is pressed. In a step 430 the keypad interface determines the character subset that is associated with the pressed key. In a step 440 the keypad interface passes the character subset to the STT 330. The STT 330 is configured to match received spoken characters only to characters in the character subset.

In a step 450 the transducer 340 receives a spoken entry and creates a digital representation of the received character. In a step 460 the STT 330 attempts to match the received spoken character to one of the characters in the character subset associated with the pressed key. The matching may include determining if the received spoken entry includes a modifier keyword, such as “upper” as previously described. Thus the STT 330 may include a limited parsing routine to determine the appropriate action to take upon receipt of the modifier keyword. If a match is determined to exist with sufficient confidence, the method 400 advances to a step 470 from which the matching character is reported to the data entry processor 350. If no match is found the method 400 returns to the step 450 to receive another spoken character. The method 400 may optionally, in a step not shown, include a counter to determine if a number of match attempts exceeds a predetermined maximum. If so, the method 400 may return to the step 410 to restart the character identification procedure.

FIG. 5 illustrates an embodiment of a system 500 in which the determination of the specified character is performed by a remote server. The system 500 includes an electronic device 510, e.g. a cell phone or small computing device, and a server 520. The server 520 may be linked to the device 510 by, e.g. a wireless connection 525 governed by UMTS, CDMA or GMS standards. Alternatively, the device 510 and the server 520 may be linked via a Wi-Fi connection (e.g. 802.11 in one of its various revision levels) to the Internet.

The device 510 may share various features described with respect to the device 300, e.g. a keypad, processor and memory (not shown). The device 510 also includes a transmitter 515 configured to communicate with the server 520 via the connection 525.

The server 520 includes a receiver 530, character discriminator 540, STT 550 and transmitter 560. The discriminator 540 and STT 550 may be implemented by, e.g. a controller or microprocessor in combination with a memory for storing program instructions and transient data.

The device 510 may be configured to transmit to the server 520 the identity of a pressed key. The key may be identified by any method consistent with the nature of the connection 525. For example, when the device 510 is a phone the key may be identified within the voice band, e.g. by DTMF signaling, or out of band by a control signal channel. Other types of electronic devices may, e.g. report the pressed key via a sequence of internet data packets. The receiver 530 receives the signal from the device 510 indicating the pressed key.

The user of the device 510 may then speak the desired character associated with the pressed key. The device 510 conveys the spoken character to the receiver 530 via the connection 525, e.g. by cellular connection or internet. The receiver 530 passes the identity of the pressed key and the spoken character to the discriminator 540. The discriminator 540 operates analogously to the keypad interface 320 to determine a subset of characters that may be associated with the pressed key, and passes the subset to the STT 550.

The STT 550 also receives the spoken command from the receiver 530. The STT 550 operates analogously to the STT 330 to determine from the spoken character which of the characters associated with the pressed key is selected by the user. The STT 550 passes the identified character to the character transmitter 560. The character transmitter 560 transmits the selected character to the device 510, e.g. via an out of band signal or an internet message. The device 510 may then register the selected character by storing the character in memory and/or displaying the character.

Turning to FIG. 6, a method 600 is presented, e.g. for forming aforementioned embodiments such as the device 300. The steps of the method 600 are described without limitation by reference to elements previously described herein, e.g. in FIGS. 3-5. The steps of the method 600 may be performed in another order than the illustrated order, and in some embodiments may be omitted altogether.

In a step 610, a keypad interface is configured to determine that a keypad key, e.g. a key of the keypad 310, has been pressed. In a step 620 a speech recognizer is configured to process a spoken entry including a spoken equivalent of a first alphanumeric character associated with the key. For example, the “2” key of the keypad 310 may be associated with “2”, “A”, “B”, or “C”, and the spoken entry may include the spoken equivalent of one of these characters. In a step 630 a data entry processor is configured to select the first alphanumeric character from among a plurality of alphanumeric characters associated with the key, e.g. “2”, “A”, “B”, or “C”, when the speech recognizer determines that the spoken entry identifies the first alphanumeric character.

In some embodiments the method 600 further includes a step 640, in which the speech recognizer is configured to constrain possible alphanumeric character matches to only alphanumeric characters associated with the pressed key.

In some of the above-described embodiments, the speech recognizer is collocated with a server remote from the electronic device.

In some of the above-described embodiments, the keypad is a telephone keypad.

In some of the above-described embodiments, the electronic device and the server are configured to communicate via a cellular communication link.

Those skilled in the art to which this application relates will appreciate that other and further additions, deletions, substitutions and modifications may be made to the described embodiments.

What is claimed is:

1. An electronic device configured to receive data from a keypad key, said key being associated with first and second alphanumeric characters, and comprising:
a keypad interface configured to determine said first and second alphanumeric characters when said key is pressed;
a data entry processor configured to select said first alphanumeric character from among said first and second alphanumeric characters when a speech recognizer determines that a spoken entry identifies said first alphanumeric character.

2. The device of claim 1, wherein said keypad is a telephone keypad.

3. The device of claim 1, wherein said keypad is a full keyboard.

4. The device of claim 3, wherein said key is a first key, said alphanumeric character is assigned to said first key, and said second alphanumeric character is assigned to a key immediately neighboring said first key.

5. The device of claim 1, wherein said speech recognizer constrains possible alphanumeric character matches to only alphanumeric characters associated with said pressed key.

6. The device of claim 1, further comprising said speech recognizer.

7. The device of claim 1, wherein said speech recognizer is provided by a remote server in communication with said electronic device.

8. The device of claim 7, wherein said device and said remote server communicate via a cellular communication link.

9. The device of claim 1, wherein said first and second alphanumeric characters are both assigned to said keypad key.

10. The device of claim 1, wherein said speech recognizer is configured to parse said spoken entry into a spoken character and a modifier keyword, and to modify said spoken character in accordance with said modifier keyword.

11. A system for entering data into an electronic device, comprising:
a receiver configured to receive keypad entry data from said electronic device;
a data discriminator configured to determine a pressed key from among at least a first key and a second key of said keypad;
a speech recognizer configured to receive a spoken entry that corresponds to a first or a second alphanumeric character associated with said pressed key; and
a character transmitter configured to transmit to said electronic device a signal indicating which of said first and second alphanumeric characters is designated by said spoken entry.

12. The system of claim 11, further comprising a cellular telephone configured to transmit said keypad entry data.

13. The system of claim 11, wherein said first and second alphanumeric characters are assigned to said key.

14. The system of claim 11, wherein said first and second alphanumeric characters are neighboring characters on said keypad.

15. The system of claim 11, wherein said speech recognizer is configured to constrain possible alphanumeric character matches to only alphanumeric characters associated with said pressed key.

16. A method of forming a keypad-operated electronic device, comprising:
providing a keypad interface configured to determine that a keypad key has been pressed;
configuring a speech recognizer to process a spoken entry including a spoken equivalent of a first alphanumeric character associated with said key;
coupling to said speech recognizer a data entry processor configured to select said first alphanumeric character from among a plurality of alphanumeric characters associated with said key when said speech recognizer determines that said spoken entry identifies the first alphanumeric character.

17. The method of claim 16, further comprising configuring said speech recognizer to constrain possible alphanumeric character matches to only alphanumeric characters associated with said pressed key.

18. The method of claim 16, wherein said keypad is a telephone keypad.

19. The method of claim 16, wherein said speech recognizer is collocated with a server remote from said electronic device.

20. The method of claim 19, wherein said electronic device and said server are configured to communicate via a cellular communication link.
